(19) United States
(12) Patent Application Publication
(10) Pub. No.: US 2014/0272505 A1
(43) Pub. Date: Sep. 18, 2014

(54) ELECTRODE ASSEMBLY AND MANUFACTURING METHOD OF SECONDARY BATTERY USING THE SAME

(71) Applicant: SAMSUNG SDI CO., LTD., Yongin-si (KR)

(72) Inventors: Jang-Ho YOON, Yongin-si (KR); Young-Min KIM, Yongin-si (KR)

(73) Assignee: SAMSUNG SDI CO., LTD., Yongin-si (KR)

(21) Appl. No.: 14/202,077

(22) Filed: Mar. 10, 2014

(30) Foreign Application Priority Data
Mar. 15, 2013 (KR) 10-2013-0028260

(51) Int. Cl. H01M 10/04

(52) U.S. Cl. CPC H01M 10/0431
USPC 429/94; 29/623.1

(57) ABSTRACT

An electrode assembly includes a positive electrode plate, a negative electrode plate, and a separator interposed between the positive and negative electrode plates, the separator having a polymer binder coating thereon, the positive electrode plate, the separator, and the negative electrode plate being sequentially stacked and wound in the shape of a jelly-roll, the jelly-roll being pressed through a heat press process.

### CROSS-REFERENCE TO RELATED APPLICATION

The present application claims priority under 35 U.S.C. §119 to Korean Patent Application No. 10-2013-0028260, filed on Mar. 15, 2013, in the Korean Intellectual Property Office, and entitled: “Electrode Assembly and Manufacturing Method of Secondary Battery Using the Same,” which is incorporated by reference herein in its entirety.

### BACKGROUND

1. Field

Embodiments relate to an electrode assembly and a manufacturing method of a secondary battery using the same.

2. Description of the Related Art

As the developments and demands of technologies for mobile devices are increased, demands on secondary batteries are rapidly increased as energy sources of the mobile devices. Secondary batteries may be generally classified into cylinder-type, prism-type (prismatic), and pouch-type batteries according to external and internal structural features thereof. Prism-type and pouch-type batteries may be particularly suitable as mobile devices are miniaturized.

### SUMMARY

Embodiments are directed to an electrode assembly, including a positive electrode plate, a negative electrode plate, and a separator interposed between the positive and negative electrode plates, the separator having a polymer binder coating thereon, the positive electrode plate, the separator, and the negative electrode plate being sequentially stacked and wound in the shape of a jelly-roll, the jelly-roll being pressed through a heat press process.

The polymer binder may include polyvinylidene fluoride (PVdF).

A value obtained by dividing an alpha phase of the PVdF by a beta phase of the PVdF after the heat press process may be about 1 to about 3.

The alpha phase may be a value measured at a wave number of 796 cm⁻¹ or 976 cm⁻¹, and the beta phase may be a value measured at a wave number of 841 cm⁻¹.

A ceramic layer may be coated between the separator and the polymer binder.

The heat press process may include pressing the jelly-roll with a pressure of about 100 to about 500 kgf.

The heat press process may be performed at a temperature of about 80 to about 130° C.

The heat press process may be performed for about 60 to about 150 seconds.

The positive electrode plate may include a positive electrode tab coupled to an end of a positive electrode collector, the positive electrode collector having a positive electrode active material layer thereon, and the negative electrode plate may include a negative electrode tab coupled to an end of a negative electrode collector, the negative electrode collector having a negative electrode active material layer thereon.

Embodiments are also directed to a method of manufacturing a secondary battery, the method including forming a jelly-roll by sequentially stacking and winding a positive electrode plate, a separator having a polymer binder coating thereon, and a negative electrode plate, and pressing the jelly-roll through a heat press process.

The polymer binder may include polyvinylidene fluoride (PVdF).

A value obtained by dividing an alpha phase of the PVdF by a beta phase of the PVdF after the pressing of the jelly-roll through the heat press process may be about 1 to about 3.

The alpha phase may be a value measured at a wave number of 796 cm⁻¹ or 976 cm⁻¹, and the beta phase is a value measured at a wave number of 841 cm⁻¹.

The heat press process may include pressing the jelly-roll with a pressure of about 100 to about 500 kgf.

The heat press process may be performed at a temperature of about 80 to about 130° C.

The heat press process may be performed for about 60 to about 150 seconds.

A ceramic layer may be coated between the separator and the polymer binder.

The method may further include inserting the jelly-roll into a prismatic battery case, injecting an electrolyte into the battery case, and sealing the battery case.

### BRIEF DESCRIPTION OF THE DRAWINGS

Features will become apparent to those of skill in the art by describing in detail example embodiments with reference to the attached drawings in which:

FIG. 1 illustrates a perspective view of an electrode assembly according to an example embodiment.

FIG. 2 illustrates a sectional view of a separator according to an example embodiment.

FIG. 3A illustrates a view showing a state in which a normal temperature press process is performed on a jelly-roll type electrode assembly having no polyvinylidene fluoride (PVdF) coated on a separator.

FIG. 3B illustrates a view showing a state in which the normal temperature press process is performed on the jelly-roll type electrode assembly having the PVdF coated on the separator.

FIG. 3C illustrates a view showing a state in which a heat press process is performed on the jelly-roll type electrode assembly having the PVdF coated on the separator.

FIG. 4 illustrates a view showing polymer structures of the PVdF.

FIG. 5A illustrates a table showing a result obtained by measuring alpha and beta phases at a specific wave number of the PVdF subjected to a normal temperature press process.

FIG. 5B illustrates a table showing a result obtained by measuring alpha and beta phases at a specific wave number of the PVdF subjected to a heat press process according to an example embodiment.

FIG. 6 illustrates a sectional view of a separator according to another example embodiment.

FIG. 7 illustrates a graph showing a change in voltage when a related art electrode assembly is initially charged and a change in voltage when the electrode assembly subjected to the heat press process according to an example embodiment is initially charged.

FIG. 8 illustrates a graph showing a change in thickness when the electrode assembly subjected to the normal temperature press process is charged and a change in thickness when the electrode assembly subjected to the heat press process according to an example embodiment is changed.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey the scope of the example embodiments to those skilled in the art.

In the following detailed description, only certain example embodiments have been shown and described, simply by way of illustration. As those skilled in the art would realize, the described example embodiments may be modified in various different ways, all without departing from the spirit or scope of the embodiments. Accordingly, the drawings and description are to be regarded as illustrative in nature and not restrictive. It will be understood that when an element is referred to as being “between” two elements, it can be the only element between the two elements, or one or more intervening elements may also be present. In addition, when an element is referred to as being “on” another element, it can be directly on the another element or be indirectly on the another element with one or more intervening elements interposed therebetween. Also, when an element is referred to as being “connected to” another element, it can be directly connected to the another element or be indirectly connected to the another element with one or more intervening elements interposed therebetween. Hereinafter, like reference numerals refer to like elements. In the drawings, the thickness or size of layers are exaggerated for clarity and not necessarily drawn to scale.

FIG. 1 illustrates a perspective view of an electrode assembly according to an example embodiment.

Referring to FIG. 1, the electrode assembly 100 according to the present example embodiment may include a positive electrode plate 110 (which may be formed by connecting a positive electrode tab 111 to one end of a positive electrode collector having a positive electrode active material layer formed thereon), a negative electrode plate 120 (which may be formed by connecting a negative electrode tab 121 to one end of a negative electrode collector having a negative electrode active material layer formed thereon), and a separator 130 interposed between the positive and negative electrode plates 110 and 120. The positive electrode plate 110, the separator 130, and the negative electrode plate 120 may be sequentially stacked and then wound in a jelly-roll shape.

In the present example embodiment, the positive electrode plate 110 includes the positive electrode collector and the positive electrode active material layer. The positive electrode active material layer may include a layered compound containing lithium, a binder for improving a coupling force, and a conducting material for improving conductivity. The positive electrode collector is generally made of aluminum. The positive electrode collector becomes a movement path of electric charges generated in the positive electrode active material layer, and performs a function of supporting the positive electrode active material layer. A positive electrode non-coating portion (not shown) having no positive electrode active material layer formed thereon is formed in the positive electrode plate 110, and the positive electrode tab 111 is connected to the positive electrode non-coating portion. The positive electrode tab 111 is generally made of aluminum, aluminum alloy, nickel or nickel alloy, etc.

In the present example embodiment, the negative electrode plate 120 includes the negative electrode collector and the negative electrode active material layer. The negative electrode active material layer may include hard carbon or graphite containing carbon, which is frequently used, and a binder for improving a coupling force between active material particles. The negative electrode collector is generally made of copper. The negative electrode collector becomes a movement path of electric charges generated in the negative electrode active material layer, and performs a function of supporting the negative electrode active material layer. A negative electrode non-coating portion (not shown) having no negative electrode active material layer formed thereon is formed in the negative electrode plate 120, and the negative electrode tab 121 is connected to the negative electrode non-coating portion. The negative electrode tab 121 is generally made of aluminum, aluminum alloy, nickel or nickel alloy, etc.

In the present example embodiment, the separator 130 is interposed between the positive and negative electrode plates 110 and 120 so as to insulate the positive and negative electrode plates 110 and 120 from each other. The separator 130 allows ions of the positive and negative electrode plates 110 and 120 to pass therethrough. The separator 130 is made of polyethylene (PE) or polypropylene (PP), etc. The separator 130 may include an electrolyte or may be formed in a liquid or gel phase, etc.

FIG. 2 illustrates a sectional view of a separator according to an example embodiment.

Referring to FIG. 2, a polymer binder may be coated on the separator 130. The polymer binder may be, for example, polyvinylidene fluorine (PVdF).

In the present example embodiment, the positive electrode plate 110, the negative electrode plate 120 and the separator 130 are sequentially stacked with the separator 130 interposed between the positive and negative electrode plates 110 and 120. The positive electrode plate 110, the negative electrode plate 120 and the separator 130 are wound using, e.g., a mandrel device. Then, one or both surfaces of the electrode assembly 100 are pressed through a heat press process.

When heat is applied to the electrode assembly 100, the phase of the PVdF coated on the separator 130 may be changed by the heat, and adhesion may occur. In the present example embodiment, the positive and negative electrode plates 110 and 120 are adhered by the adhesion with the separator 130 interposed therebetween, and the positive electrode plate 110, the separator 130 and the negative electrode plate 120 are adhered closely to one another so as to maintain the adhered state even after the heat press process is finished.

The heat press process may be performed with a pressure of about 100 to about 500 kgf, e.g., about 200 kgf, at a temperature of about 80 to about 130° C. for about 60 to about 150 seconds. In a case where the temperature is about 80° C. or more, the effect of maintaining the adhesion among the positive electrode plate 110, the separator 130, and the negative electrode plate 120 may be enhanced. In a case where the temperature is about 130° C. or less, pores of the separator 130 may not be blocked due to a change in the material of the separator 130.

FIG. 3A illustrates a view showing a state in which a normal temperature press process is performed on a jelly-roll type electrode assembly having no PVdF coated on a separator. FIG. 3B is a view showing a state in which the normal temperature press process is performed on the jelly-roll type electrode assembly having the PVdF coated on the separator. FIG. 3C is a view showing a state in which a heat press process is performed on the jelly-roll type electrode assembly having the PVdF coated on the separator.

Referring to FIG. 3A, it can be seen that a gap occurs between the positive and negative electrode plates after the normal temperature press process is performed. In FIG. 3B, it can also be seen that a certain gap occurs between the positive and negative electrode plates even though the adhesion is higher than that in FIG. 3A.

However, referring to FIG. 3C, it can be seen that in the jelly-roll type electrode assembly having the PVdF coated on the separator, the adhesion between the positive and negative electrode plates is substantially maintained even after the heat press process is performed, thereby maintaining the reduced thickness of the electrode assembly when the heat press process is performed. Without being bound by theory, it is believe that this is because the positive and negative electrode plates are adhered to the separator by the thermal deformation of the PVdF coated on the separator.

After the heat press process is performed on the electrode assembly 100, the PVdF coated on the separator 130 may form an alpha or beta solid structure shown in FIG. 4(a) or 4(b) according to the crystallization temperature when being quenched in a melting state. The PVdF coated on the separator 130 forms a gamma solid structure shown in FIG. 4(c) in a casting state.

According to the present example embodiment, a value obtained by dividing the alpha phase of the PVdF by the beta phase of the PVdF (α/β) after the heat press process is about 1 to about 3.

FIG. 5A is a table showing a result obtained by measuring alpha and beta phases at a specific wave number of the PVdF subjected to a normal temperature press process. FIG. 5B is a table showing a result obtained by measuring alpha and beta phases at a specific wave number of the PVdF subjected to a heat press process according to an example embodiment. According to the present example embodiment, the alpha and beta phase measured by FT-IR (Fourier Transform Infrared Spectroscopy). As will be apparent to one of ordinary skill in the art from the description and drawings, the results of the wave number measurements are absorption coefficients for the respective alpha and beta phases.

Referring to FIG. 5A, in a case where the normal temperature press process is performed, the average values obtained by dividing a beta phase measured at a specific wave number of 841 cm⁻¹ into alpha phases measured specific wave numbers of 976 cm⁻¹ and 796 cm⁻¹ are 5.263 and 3.591, respectively.

On the other hand, referring to FIG. 5B, in a case where the heat press process is performed, the values obtained by dividing the beta phase measured at a specific wave number of 841 cm⁻¹ into the alpha phases measured specific wave numbers of 976 cm⁻¹ and 796 cm⁻¹ are 2.119 and 2.143, respectively. Thus, it can be seen that the value is within a range of about 1 to about 3.

Thus, in a case where the heat press process is performed on the electrode assembly 100, the alpha phase of the PVdF coated on the separator is decreased, and the beta phase of the PVdF coated on the separator is increased. Accordingly, the value obtained by dividing the beta phase into the alpha phase is decreased.

FIG. 6 illustrates a sectional view of a separator according to another example embodiment.

Referring to FIG. 6, a ceramic layer may be coated on one surface of the separator 130, and PVdF is coated on the other surface of the separator 130 and the ceramic layer.

In a case where the ceramic layer is coated between the PVdF and the separator 130, it may be possible to improve the adhesion between the positive electrode 110, the separator 130, and the negative electrode plate 120. Porosity may be high because of characteristics of the ceramic layer. Thus, the moisturization of an electrolyte may be fast, so that the injection speed of the electrolyte may be increased. Further, the stability of the electrolyte may be enhanced, so that battery lifetime and discharging characteristics may be improved.

An example embodiment of a manufacturing method of a secondary battery including an electrode assembly will now be described.

According to the present example embodiment, first, a positive electrode plate, a separator having PVdF as a polymer binder coated on both surfaces thereof, and a negative electrode plate are sequentially stacked and then wound, thereby foaming a jelly-roll. Subsequently, the jelly-roll is pressed through a heat press process. In the present example embodiment, the heat press process may be performed with a pressure of about 100 to about 500 kgf, e.g., about 200 kgf, at a temperature of about 80 to about 130° C. for about 60 to about 150 seconds. Finally, the jelly-roll subjected to the heat press process is accommodated in a prismatic battery case, and the battery case having an electrolyte injected therein is sealed, thereby manufacturing the secondary battery.

In the present example embodiment, a small amount of the electrolyte is generally injected into the battery case, and pre-charging is generally performed to activate the battery in a state in which the injection hole of the battery case is not sealed. Subsequently, gas generated in initial charging is degassed, and the electrolyte is again injected into the battery case. Subsequently, an aging process is performed to provide a time at which the electrolyte can be uniformly distributed, and the battery case is then sealed for performing secondary charging.

The following Examples and Comparative Examples are provided in order to highlight characteristics of one or more embodiments, but it will be understood that the Examples and Comparative Examples are not to be construed as limiting the scope of the embodiments, nor are the Comparative Examples to be construed as being outside the scope of the embodiments. Further, it will be understood that the embodiments are not limited to the particular details described in the Examples and Comparative Examples.

FIG. 7 illustrates a graph showing a change in voltage when a related art electrode assembly is initially charged and a change in voltage when an electrode assembly subjected to the heat press process according to an example embodiment is initially charged.

Comparative Example 1 shows a result of the electrode assembly on which the normal temperature press process is performed in a state in which no PVdF is coated on the separator. Comparative Example 2 shows a result of the electrode assembly on which the normal temperature process is performed in a state in which the PVdF is coated on the separator. The Example shows a result of the electrode assembly on which the heat press process according to an example embodiment is performed in a state in which the PVdF is coated on the separator.

Referring to FIG. 7, it can be seen that the overvoltage in initial charging in the Example is decreased as compared with that in Comparative Examples 1 and 2. Without being bound by theory, it is believed that this is because the positive electrode plate, the separator, and the negative electrode plate are maximally adhered to one another in the electrode assembly subjected to the heat press process, and thus, the non-uniformity of a non-charging region in the initial charging is improved as compared with that in Comparative Examples 1 and 2.

FIG. 8 illustrates a graph showing a change in thickness when the electrode assembly subjected to a normal temperature press process is charged and a change in thickness when the electrode assembly subjected to the heat press process according to an example embodiment is changed.

Referring to FIG. 8, in the electrode assembly subjected to a normal temperature press process according to a comparative example, a change in thickness is very significant in initial charging. The thicknesses before and after secondary charging are 92.3 and 96, respectively, in which the variation in thickness is 3.7. On the other hand, in the electrode assembly subjected to the heat press process according to an example embodiment, a change in thickness is small in initial charging. The thicknesses before and after secondary charging are 92.1 and 92.7, respectively, in which the variation in thickness is merely 0.6.

Thus, in the electrode assembly subjected to the heat press process according to an example embodiment, the variation in thickness may be substantially reduced even in the initial charging. Thus, an electrode assembly in which a positive electrode plate, a separator, and a negative electrode plate are further stacked, as compared with a general electrode assembly, may be wound and inserted into the battery case having the same capacity. Accordingly, it may be possible to improve the capacity or volumetric efficiency of the secondary battery.

By way of summation and review, an electrode assembly for a battery reaction in a secondary battery may have a structure in which an electrolyte is immersed into positive and negative electrode plates respectively having positive and negative electrode active materials coated thereon and a separator interposed therebetween. The electrode assembly of the secondary battery may be generally described as a jelly-roll type (wound-type) electrode assembly and a stacked-type electrode assembly according to structures thereof. Thus, a prism-type secondary battery may be manufactured by accommodating a jelly-roll type electrode assembly or stacked-type electrode assembly in a prism-type case.

In case of the jelly-roll type electrode assembly, a jelly-roll may be pressed through a press before the jelly-roll type electrode assembly is inserted into the prism-type case. In this case, the jelly-roll may maintain flatness to a certain degree at the time when the jelly-roll is pressed, and then have a thickness thinner than the initial thickness of the jelly-roll after an external force applied by the press is removed. However, the thickness of the jelly-roll may return to the initial thickness to a certain degree. If the jelly-roll is inserted into a metal case, the case may surround the jelly-roll by an external force thereof, but the external force may not allow the positive and negative electrode plates of the electrode assembly to be sufficiently adhered closely to each other.

Therefore, in a case where an electrolyte is injected into a prism-type metal can in a general secondary battery, the charging state of the secondary battery may be scattered or varied due to inequality of the distance between positive and negative electrode plates, and therefore, gas or the like may be generated. In this case, the thickness of the secondary battery may be changed by the generated gas.

As described above, embodiments relate to an electrode assembly and a manufacturing method of a secondary battery using the same, in which a distance between adhered positive and negative electrode plates of a jelly-roll type electrode assembly may be reduced in the secondary battery.

According to an embodiment, it may be possible to maintain a state in which the positive electrode plate, the separator, and the negative electrode plate in the electrode assembly are maximally adhered closely to one another.

Further, a change in thickness may be reduced or avoided even in initial charging and secondary charging of the secondary battery having the electrode assembly according to an embodiment inserted therein.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. An electrode assembly, comprising:
a positive electrode plate;
a negative electrode plate; and
a separator interposed between the positive and negative electrode plates, the separator having a polymer binder coating thereon, the positive electrode plate, the separator, and the negative electrode plate being sequentially stacked and wound in the shape of a jelly-roll, the jelly-roll being pressed through a heat press process.

2. The electrode assembly as claimed in claim 1, wherein the polymer binder includes polyvinylidene fluoride (PVdF).

3. The electrode assembly as claimed in claim 2, wherein a value obtained by dividing an alpha phase of the PVdF by a beta phase of the PVdF after the heat press process is about 1 to about 3.

4. The electrode assembly as claimed in claim 3, wherein the alpha phase is a value measured at a wave number of 796 cm⁻¹ or 976 cm⁻¹, and the beta phase is a value measured at a wave number of 841 cm⁻¹.

5. The electrode assembly as claimed in claim 1, wherein a ceramic layer is coated between the separator and the polymer binder.

6. The electrode assembly as claimed in claim 1, wherein the heat press process includes pressing the jelly-roll with a pressure of about 100 to about 500 kgf.

7. The electrode assembly as claimed in claim 1, wherein the heat press process is performed at a temperature of about 80 to about 130° C.

8. The electrode assembly as claimed in claim 1, wherein the heat press process is performed for about 60 to about 150 seconds.

9. The electrode assembly as claimed in claim 1, wherein:
the positive electrode plate includes a positive electrode tab coupled to an end of a positive electrode collector, the positive electrode collector having a positive electrode active material layer thereon, and
the negative electrode plate includes a negative electrode tab coupled to an end of a negative electrode collector, the negative electrode collector having a negative electrode active material layer thereon.

10. A method of manufacturing a secondary battery, the method comprising:
forming a jelly-roll by sequentially stacking and winding a positive electrode plate, a separator having a polymer binder coating thereon, and a negative electrode plate; and
pressing the jelly-roll through a heat press process.

11. The method as claimed in claim 10, wherein the polymer binder includes polyvinylidene fluoride (PVdF).

12. The method as claimed in claim 11, wherein a value obtained by dividing an alpha phase of the PVdF by a beta phase of the PVdF after the pressing of the jelly-roll through the heat press process is about 1 to about 3.

13. The method as claimed in claim 12, wherein the alpha phase is a value measured at a wave number of 796 cm⁻¹ or 976 cm⁻¹, and the beta phase is a value measured at a wave number of 841 cm⁻¹.

14. The method as claimed in claim 10, wherein the heat press process includes pressing the jelly-roll with a pressure of about 100 to about 500 kgf.

15. The method as claimed in claim 10, wherein the heat press process is performed at a temperature of about 80 to about 130° C.

16. The method as claimed in claim 10, wherein the heat press process is performed for about 60 to about 150 seconds.

17. The method as claimed in claim 10, wherein a ceramic layer is coated between the separator and the polymer binder.

18. The method as claimed in claim 10, further comprising inserting the jelly-roll into a prismatic battery case, injecting an electrolyte into the battery case, and sealing the battery case.
